(19) United States
(12) Patent Application Publication
(10) Pub. No.: US 2016/0057159 A1
(43) Pub. Date: Feb. 25, 2016

(54) SEMANTICS-AWARE ANDROID MALWARE CLASSIFICATION

(71) Applicants: Heng Yin, Manlius, NY (US); Mu Zhang, Syracuse, NY (US); Yu Duan, Syracuse, NY (US); Zhiruo Zhao, Syracuse, NY (US)

(72) Inventors: Heng Yin, Manlius, NY (US); Mu Zhang, Syracuse, NY (US); Yu Duan, Syracuse, NY (US); Zhiruo Zhao, Syracuse, NY (US)

(73) Assignee: SYRACUSE UNIVERSITY, Syracuse, NY (US)

(21) Appl. No.: 14/833,491

(22) Filed: Aug. 24, 2015

Related U.S. Application Data
(60) Provisional application No. 62/041,015, filed on Aug. 22, 2014.

(51) Int. Cl. H04L 29/06; G06F 17/30

(52) U.S. Cl. CPC H04L 63/145; G06F 17/30312; G06F 17/30958; G06F 17/30864

(57) ABSTRACT

A semantic-based approach that classifies Android malware via dependency graphs. To battle transformation attacks, a weighted contextual API dependency graph is extracted as program semantics to construct feature sets. To fight against malware variants and zero-day malware, graph similarity metrics are used to uncover homogeneous application behaviors while tolerating minor implementation differences.

### CROSS-REFERENCE TO RELATED APPLICATIONS

The present application claims priority to U.S. Provisional Application No. 62/041,015, filed on Aug. 22, 2014.

### STATEMENT REGARDING FEDERALLY SPONSORED RESEARCH

This invention was made with government support under Grant Nos. 1018217 and 1054605 awarded by the National Science Foundation (NSF). The government has certain rights in the invention.

### BACKGROUND OF THE INVENTION

1. Field of the Invention

The present invention relates to malware prevention and, more specifically, to a semantic-based approach that classifies malware via dependency graphs for more expedient removal.

2. Description of the Related Art

The drastic increase of Android malware led to a strong interest in developing methods to automate the malware analysis process. Existing automated Android malware detection and classification methods fall into two general categories: 1) signature-based and 2) machine learning-based. Signature-based approach can be easily evaded by bytecode-level transformation attacks. Prior learning-based works extract features from application syntax rather than program semantics and are also subject to evasion.

To directly address malware that evades automated detection, prior works distill program semantics into graph representations, such as control-flow graphs, data dependency graphs and permission event graphs. These graphs are checked against manually-crafted specifications to detect malware. However, these detectors tend to seek an exact match for a given specification and therefore can potentially still be evaded by polymorphic variants. Furthermore, the specifications used for detection are produced from known malware families and cannot be used to battle zero-day malware.

### BRIEF SUMMARY OF THE INVENTION

The present invention comprises a semantic-based approach that classifies Android malware via dependency graphs. To battle transformation attacks, a weighted contextual API dependency graph is extracted as program semantics to construct feature sets. The subsequent classification then depends on more robust semantic-level behavior rather than program syntax. It is much harder for an adversary to use an elaborate bytecode-level transformation to evade such a training system. To fight against malware variants and zero-day malware, graph similarity metrics are introduced to uncover homogeneous application behaviors while tolerating minor implementation differences. A prototype system DroidSIFT was implemented in 23 thousand lines of Java code and evaluated 2200 malware samples and 9500 benign samples. Experiments show that the signature detection of the present invention can correctly label 93% of malware instances; while the anomaly detector is capable of detecting zero-day malware with a low false negative rate (2%) and an acceptable false positive rate (6.3%) for a vetting purpose.

A database of behavior graphs for a collection of Android apps was built. Each graph models the API usage scenario and program semantics of the app that it represents. Given a new app, a query is made for the app's behavior graphs to search for the most similar counterpart in the database. The query result is a similarity score which sets the corresponding element in the feature vector of the app. Every element of this feature vector is associated with an individual graph in the database.

Graph databases are built for two sets of behaviors: benign and malicious. Feature vectors extracted from these two sets are then used to train two separate classifiers for anomaly detection and signature detection. The former is capable of discovering zero-day malware, and the latter is used to identify malware variants.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is schematic of the deployment of DroidSIFT;

FIG. 2 is a schematic overview of DroidSIFT;

FIG. 3 is a flowchart of the WC-ADG of Zitmo;

FIG. 4 is a callgraph for asynchronously sending an SMS message;

FIG. 5 is the stub code for dataflow of AsyncTask.execute

FIG. 6 is a schematic of a feedback loop to solve the optimization problem;

FIG. 7 is a bucket-based indexing of graph database;

FIG. 8 is a chart of an example of feature vectors;

FIG. 9 is a series of graphs summarizing generation;

FIG. 10 is a graph of convergence of unique graphs in benign apps;

FIG. 11 is a graph of the detection ratio for obfuscated malware;

FIG. 12 is a graph of the detection runtime for 3000 benign and malicious apps;

FIG. 13 is a graph of the similarity between malicious graph pairs; and

FIG. 14 is a graph of the similarity between benign and malicious graphs.

### DETAILED DESCRIPTION OF THE INVENTION

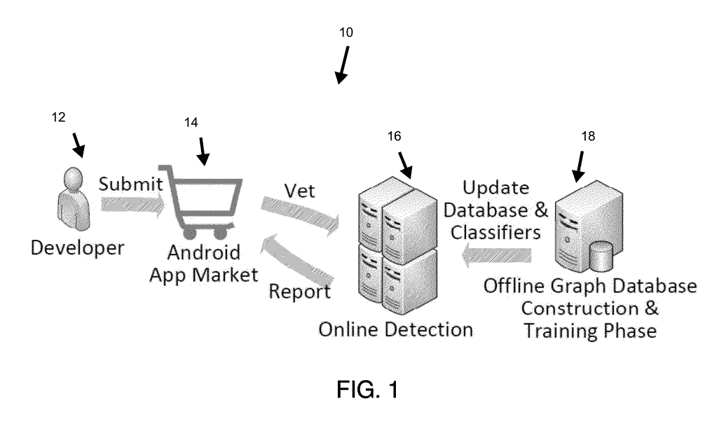

Referring now to the drawings, wherein like reference numerals refer to like parts throughout, there is seen in FIG. 1, a system 10 for malware classification and detection, referred to as DroidSIFT, that addresses the shortcomings of conventional systems and can be deployed as a replacement for existing vetting techniques currently used by Android app markets. This technique is based on static analysis, which is immune to emulation detection and is capable of analyzing the entirety of the code of an application. Furthermore, to defeat bytecode-level transformations, the static analysis is semantics-aware and extracts program behaviors at the semantic level. More specifically, the following design goals are met:

Semantic-based Detection. System 10 detects malware instances based on their program semantics. It does not rely on malicious code patterns, external symptoms, or heuristics. The system is able to perform program analysis for both the interpretation and demonstration of inherent program dependencies and execution contexts.

High Scalability. System 10 scales well to cope with millions of unique benign and malicious Android app samples. It also addresses the complexity of static program analysis as it can be considerably expensive, in terms of both time and memory resources, to perform a precise static analysis of a program.

Variant Resiliency. System 10 is resilient to polymorphic variants. It is common for attackers to implement malicious functionalities in slightly different manners and still be able to perform the expected malicious behaviors. This malware polymorphism can defeat detection methods that are based on exact behavior matching, which is the method prevalently adopted by existing signature-based detection and graph-based model checking To address this, system 10 is able to measure the similarity of app behaviors and tolerate such implementation variants with similarity scores.

Consequently, system 10 conducts two kinds of classifications: anomaly detection and signature detection. Upon receiving a new application submission from a developer 12 via an Android application market 14, an online detection processor 16 conducts anomaly detection to determine whether the submitted application contains behaviors that significantly deviate from the benign applications within an associated database 18. If such a deviation is discovered, a potential malware instance is identified and further signature detection is performed by processor 16 to determine if the application falls into any malware family within a signature database 18. If so, the application is flagged as malicious and reported back to developer 12 via the Android application market 14 immediately. If the application passes this hurdle, it is still possible that a new malware species has been found. Thus, the detailed report sent to developer 12 when suspicious behaviors that deviate from benign behaviors are discovered includes a request for a justification for the deviation. The application is approved only after developer 12 makes a convincing justification for the deviation. Otherwise, after further investigation, the application may be confirmed to be a new malware species and then placed into malware database 18 to further improve signature detection and detect this new malware species in the future.

It is also possible to deploy system with more ad-hoc schemes. For example, detection mechanism of detection processor 16 can be deployed as a public service that allows a cautious application user to examine an application prior to its installation. An enterprise that maintains its own private application repository can also utilize detection mechanism of detection processor 16 such a security service. The enterprise service conducts vetting prior to adding an application to the internal application pool, thereby protecting employees from application that contain malware behaviors.

2.2 Architecture Overview

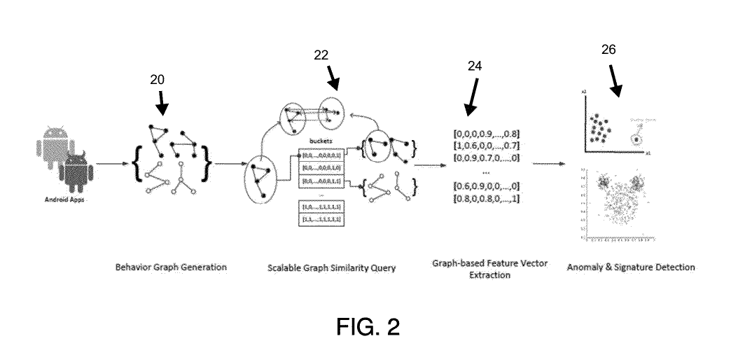

FIG. 2 depicts the workflow of the graph-based Android malware classification of system 10. System 10 involves the following modules or process steps, which may be programmed to be performed by detection processor 16:

Behavior graph generation 20 involves the use of graph similarity as the feature. To this end, a static program analysis is performed to transform Android bytecode programs into their corresponding graph representations. The program analysis includes entry point discovery and call graph analysis to understand the API calling contexts, and leverages both forward and backward dataflow analysis to explore API dependencies and uncover any constant parameters. The result of this analysis is expressed with weighted contextual API dependency graphs, which expose the security-related behaviors of Android apps.

Scalable graph similarity query 22 involves generating graphs for both benign and malicious application and then querying the graph database for the one that is most similar to a given graph. To address scalability, a bucket based indexing scheme is used to improve search efficiency. Each bucket contains those graphs bearing APIs from the same Android packages and is indexed with a bitvector that indicates the presence of such packages. Given a graph query, the corresponding bucket index can be quickly sought by matching the package's vector to the bucket's bitvector. Once a matching bucket is located, the bucket is further iterated to find the best-matching graph. Finding the best-matching graph, instead of an exact match, is necessary to identify polymorphic malware.

Graph-based feature vector extraction 24 finds the best match for each of its graphs from the database. This produces a similarity feature vector where each element of the vector is associated with an existing graph in the database. This vector bears a non-zero similarity score in one element only if the corresponding graph is the best match to one of the graphs for the given app.

Anomaly and signature detection 26 implements a signature classifier and an anomaly detector. Feature vectors are produced for malicious applications and these vectors are provided to train a classifier for signature detection. Anomaly detection discovers zero-day Android malware, and signature detection uncovers the type (family) of the malware.

3. Weighted Contextual API Dependency Graph

In order to illustrate how an embodiment of system 10 can capture the semantic-level behaviors of Android malware in the form of graphs, the present invention identifies the key behavioral aspects that need to be captured, presents a formal definition, and then presents a real example to demonstrate these aspects.

3.1 Key Behavioral Aspects

The following aspects are essential when describing the semantic-level behaviors of a piece of Android malware:

API Dependency. API calls (including reflective calls to the private framework functions) indicate how an app interacts with the Android framework. It is essential to capture what API calls an app can make and the dependencies among those calls. Prior works on semantic- and behavior-based malware detection and classification for desktop environments all make use of API dependency information. Android malware shares the same characteristics.

Context. An entry point of an API call is a program entry point that directly or indirectly triggers this API. From user-awareness point of view, there are two kinds of entry points: user interfaces and background callbacks. Malware authors commonly exploit background entry points to enable malicious functionalities without the user's knowledge. From a security analyst's perspective, it is a more suspicious behavior if a supposedly user interactive API (e.g., AudioRecord. startRecording ( )) is called stealthily. As a result, special attention must be paid to APIs activated from background entry points.

Constant. Constants convey semantic information by revealing the values of critical parameters and uncovering fine-grained API semantics. For instance, Runtime.exec ( ) may execute varied shell commands, such as ps or chmod, depending on the input string constant. Constant analysis also discloses the data dependencies of certain security-sensitive APIs, whose benignness is dependent upon whether an input is constant. For example, a sendTextMessage ( ) call taking a constant premiumrate phone number is a more suspicious behavior than the call to the same API receiving the phone number from a user input through getText ( ). Consequently, it is crucial to extract constant information for security analysis.

Once application behaviors using these three perspectives are identified, similarity checking must be performed on the behavioral graphs, rather than seeking an exact match. Since each individual API node plays a distinctive role in an app, it contributes differently to graph similarity. With regard to malware detection, security-sensitive APIs combined with critical contexts or constant parameters are emphasized. Weights are assigned to different API nodes, giving greater weights to the nodes containing critical calls, to improve the “quality” of behavior graphs when measuring similarity. Moreover, the weight generation may be automated and thus similar graphs have higher similarity scores by design.

3.2 Formal Definition

To address all of the aforementioned factors, app behaviors are analyzed using Weighted Contextual API Dependency Graphs (WC-ADG). At a high level, a WC-ADG consists of API operations where some of the operations have data dependencies. A formal definition is presented as follows.

Definition 1. A Weighted Contextual API Dependency Graph is a directed graph G=(V, E, a, β) over a set of API operations E and a weight space W, where:

The set of vertices V corresponds to the contextual API operations in E;

The set of edges E ⊂ V×V corresponds to the data dependencies between operations;

The labeling function α: V→Σ associates nodes with the labels of corresponding contextual API operations, where each label is comprised of 3 elements: API prototype, entry point and constant parameter;

The labeling function β: V→W associates nodes with their corresponding weights, where ∀w ∈ W, w ∈ R, and R represents the space of real numbers.

3.3 A Real Example

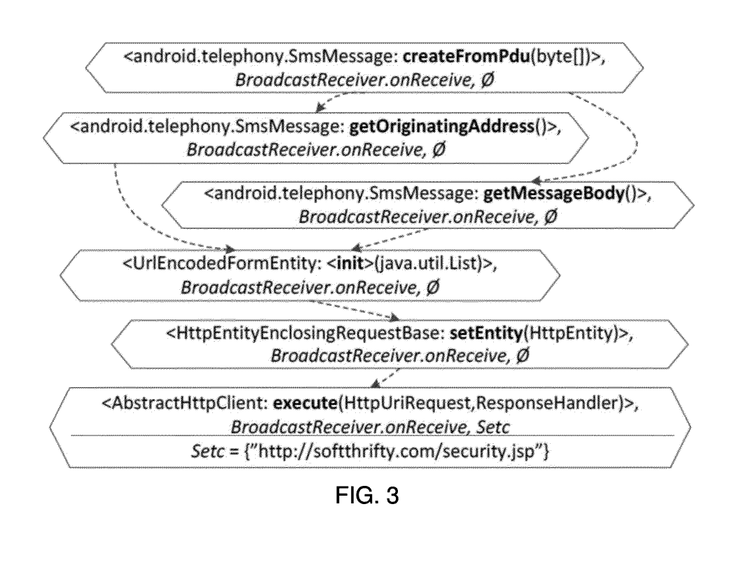

Zitmo is a class of banking trojan malware that steals a user's SMS messages to discover banking information (e.g., mTANs). FIG. 3 presents an example WC-ADG that depicts the malicious behavior of a Zitmo malware sample in a concise, yet complete, manner. This graph contains five API call nodes. Each node contains the call's prototype, a set of constant parameters, and the entry points of the call. A dashed arrow connecting a pair of nodes indicates that a data dependency exists between the two calls.

By combining the knowledge of API prototypes with the data dependency information shown in the graph, system 10 can determine that the app is forwarding an incoming SMS to the network. Once an SMS is received by the mobile phone, Zitmo creates an SMS object from the raw Protocol Data Unit by calling createFromPdu (byte [ ]). It extracts the sender's phone number and message content by call getOriginatingAddress( ) and getMessageBody( ). Both strings are encoded into an UrlEncodedFormEntity object and enclosed into httpEntityEnclosingRequestBase by using the setEntity ( ) call. Finally, this HTTP request is sent to the network via AbstractHttpClient.execute ( ).

Zitmo variants may also exploit various other communication related API calls for the sending purpose. Another Zitmo instance uses SmsManager.sendTextMessage ( ) to deliver the stolen information as a text message to the attacker's phone. Such variations motivate us to consider graph similarity metrics, rather than an exact matching of API call behavior, when determining whether a sample app is benign or malicious.

The context provided by the entry points of these API calls indicates that the user is not aware of this SMS forwarding behavior. These consecutive API invocations start within the entry point method onReceive ( ) with a call to createFromPdu (byte [ ]). The onReceive ( ) here is a broadcast receiver registered by the app to receive incoming SMS messages in the background. The createFromPdu (byte [ ]) and subsequent API calls are activated from a non-user-interactive entry point and hidden from the user.

Constant analysis of the graph further indicates that the forwarding destination is suspicious. The parameter of execute ( ) is neither the sender (i.e., the bank) nor any familiar parties from the contacts. It is a constant URL belonging to an unknown third-party.

3.4 Graph Generation

A graph generation tool was implemented on top of Soot in 20k lines of code. The tool examines an Android app to conduct entry point discovery and perform context-sensitive, flow-sensitive, and interprocedural dataflow analyses. These analyses locate API call parameters and return values of interest, extract constant parameters, and determine the data dependency among the API calls.

Entry Point Discovery.

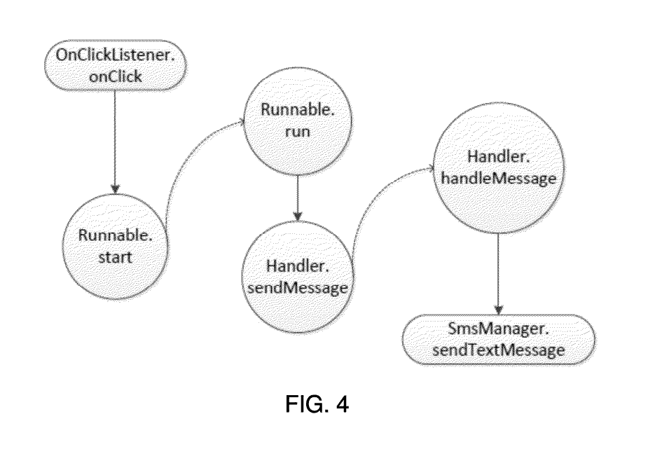

Entry point discovery is essential to revealing whether the user is aware that a certain API call has been made. However, this identification is not straightforward. Consider the callgraph seen in FIG. 4. This graph describes a code snippet that registers an onClick ( ) event handler for a button. From within the event handler, the code starts a thread instance by calling Thread.start ( ), which invokes the run ( ) method implementing Runnable.run ( ). The run ( ) method passes an android.os.Message object to the message queue of the hosting thread via Handler.sendMessage ( ).

A Handler object created in the same thread is then bound to this message queue and its Handler.handleMessage( ) call back will process the message and later execute sendTextMessage ( ).

The sole entry point to the graph is the user-interactive callback onClick ( ). However, prior work on the identification of program entry points does not consider asynchronous calls and recognizes all three callbacks in the program as individual entry points. It thus confuses the determination of whether a user is aware that an API call has been made in response to a user-interactive callback. To address this limitation, system 10 uses Algorithm 1 to remove any “possible” entry point that is actually part of an asynchronous call chain that has only a single entry point.

Algorithm 1 Entry Point Reduction for Asynchronous Callbacks

M_{entry} ← {Possible entry point callback methods}
CM_{async} ← {Pairs of (BaseClass, RunMethod) for asynchronous
calls in framework}
RS_{async} ← {Map from RunMethod to StartMethod for asyn-
chronous calls in framework}
for m_{entry} ∈ M_{entry} do

c ← the class declaring m_{entry}
base ← the base class of c
if (base, m_{entry}) ∈ CM_{async} then

mₛₜₐᵣₜ ← Lookup(m_{entry}) in RS_{async}
for ∀ call to mₛₜₐᵣₜ do

r ← “this” reference of call
PointsToSet ← PointsToAnalysis(r)
if c ∈ PointsToSet then

M_{entry} = M_{entry} − {m_{entry}}
BuildDependencyStub(mₛₜₐᵣₜ, m_{entry})

end if

end for

end if

end for
output M_{entry} as reduced entry point set

Algorithm 1 accepts three inputs and provides one output. The first input is M_{entry}, which is a set of possible entry points. The second is CM_{async}, which is a set of (BaseClass, RunMethod) pairs. BaseClass represents a top-level asynchronous base class (e.g., Runnable) in the Android framework and RunMethod is the asynchronous call target (e.g., Runnable.run ( )) declared in this class. The third input is RS_{async}, which maps RunMethod to StartMethod. RunMethod and StartMethod are the callee and caller in an asynchronous call (e.g., Runnable. run( ) and Runnable.start ( )). The output is a reduced M_{entry} set.

The M_{entry} input is computed by applying a conventional algorithm which discovers all reachable callback methods defined by the app that are intended to be called only by the Android framework. To further consider the logical order between Intent senders and receivers, Epic is leveraged to resolve the inter-component communications and then remove the Intent receivers from M_{entry}.

Through examination of the Android framework code, a list of 3-tuples consisting of BaseClass, RunMethod and StartMethod is generated. For example, the Android-specific calling convention of AsyncTask with AsyncTask is captured. onPreExecute ( ) being triggered by AsyncTask. execute ( ). When a new asynchronous call is introduced into the framework code, this list is updated to include the change. Table 1 presents an example for the calling convention of top-level base asynchronous classes in Android framework.

TABLE 1
Calling Convention of Asynchronous Calls

| Top-level Class | Start Method | Run Method |
|---|---|---|
| Runnable | run ( ) | start ( ) |
| AsyncTask | execute ( ) | onPreExecute ( ) |
| AsyncTask | onPreExecute ( ) | doInBackground ( ) |
| AsyncTask | doInBackground ( ) | onPostExecute ( ) |
| Message | sendMessage ( ) | handleMessage ( ) |

Given these inputs, the algorithm iterates over M_{entry}. For every method m_{entry} in this set, it first finds the class c declaring this method as well as the top-level base class base that c inherits from. Then, it searches the pair of base and m_{entry} in the CM_{async} set. If a match is found, that means this method m_{entry} is a “callee” by convention. The algorithm thus looks up m_{entry} in the map SRa3ync to find the corresponding “caller” mₛₜₐᵣₜ. Each call to mₛₜₐᵣₜ is further examined and a points-to analysis is performed on the “this” reference making the call. If class c of method m_{entry} belongs to the points-to set, the algorithm can ensure the calling relationship between the caller mₛₜₐᵣₜ and the callee m_{entry} and remove the callee from the entry point set.

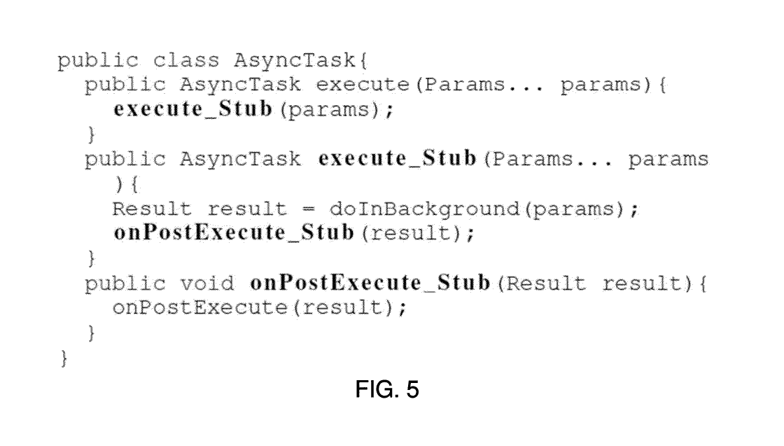

To indicate the data dependency between these two methods, a stub which connects the parameters of the asynchronous call to the corresponding parameters of its callee is introduced. FIG. 5 depicts the example stub code for AsyncTask, where the parameter of execute ( ) is first passed to doInBackground ( ) through the stub execute_Stub ( ), and then the return from this asynchronous execution further transferred to onPostExecute ( ) via onPostExecute_Stub ( ).

Once the algorithm has reduced the number of entry point methods in M_{entry}, all code reachable from those entry points is explored, including both synchronous and asynchronous calls. The user interactivity of an entry point is determined by examining its top-level base class. If the entry point callback overrides a counterpart declared in one of the three top-level UI-related interfaces (i.e., android. graphics.drawable.Drawable.Callback, android.view.accessibility.AccessibilityEventSource, and android.view.KeyEvent.Callback), the derived entry point method is considered as a user interface.

Constant Analysis

Constant analysis is conducted for critical parameters of security sensitive API calls. These calls may expose security-related behaviors depending on the values of their constant parameters. For example, Runtime.exec ( ) can directly execute shell commands, and file or database operations can interact with distinctive targets by providing the proper URIs as input parameters.

To understand these semantic-level differences, backward dataflow analysis is performed on selected parameters and all possible constant values on the backward trace are collected. A constant set is generated for each critical API argument and mark the parameter as “Constant” in the corresponding node on the WC-ADG. While a more complete string constant analysis is also possible, the computation of regular expressions is fairly expensive for static analysis. The substring set currently generated effectively reflects the semantics of a critical API call and is sufficient for further feature extraction.

API Dependency Construction.

Global dataflow analysis is considered to discover data dependencies between API nodes and build the edges on WC-ADG. However, it is very expensive to analyze every single API call made by an app. To address computational efficiency and interests on security analysis, only the security-related API calls are analyzed. Permissions are strong indicators of security sensitivity in Android systems, so the API-permission mapping from Pscout is leveraged to focus on permission-related API calls.

The static dataflow analysis is similar to the “split”-based approach used by CHEX. Each program split includes all code reachable from one single entry point. Dataflow analysis is performed on each split, and then cross-split dataflows are examined. The difference between the present invention and that of CHEX lies in the fact that system 10 has computed larger splits due to the consideration of asynchronous calling conventions.

Special consideration for reflective calls in taken in the present invention. In Android programs, reflection is realized by calling the method java.lang.reflect.Method.invoke( ). The “this” reference of this API call is a Method object, which is usually obtained by invoking either getMethod ( ) or getDeclaredMethod ( ) from java.lang.Class. The class is often acquired in a reflective manner too, through Class.forName ( ). This API call resolves a string input and retrieves the associated Class object.

During analysis, any reflective invoke ( ) call is considered as a sink and backward dataflow analysis is conducted to find any prior data dependencies. If such an analysis reaches string constants, the class and method information are statically resolved. Otherwise, the reflective call is not statically resolvable. However, statically unresolvable behavior is still represented within the WC-AD G, where there exists no constant parameter fed into this call. Instead, this reflective call may have several preceding APIs, from a dataflow perspective, which are the sources of its metadata.

4. Android Malware Classification

WC-ADGs are generated for both benign and malicious apps, and each unique graph is associated to a feature, with which are then classified malicious and benign Android applications.

4.1 Graph Matching Score

To quantify the similarity of two graphs, a graph edit distance is first computer. To knowledge, all existing graph edit distance algorithms treat node and edge uniformly. However, in the present case, the graph edit distance calculation must take into account the different weights on different API nodes. At present, assigning different weights on edges would lead to prohibitively high complexity in graph matching. Moreover, to emphasize the differences between two nodes in different labels, they are not relabeled. Instead, the old node is deleted and the new one inserted subsequently.

Definition 2. The Weighted Graph Edit Distance (WGED) of two Weighted Contextual API Dependency Graphs G and G′, with a uniform weight function 0, is the minimum cost to transform G to G′:

$$wged ( G , {G}^{′} , β ) = min ( {\sum }_{{v}_{I} ∈ \{ {V}^{′} - V \}} β ( {v}_{I} ) + {\sum }_{{v}_{D} ∈ \{ V - {V}^{′} \}} β ( {v}_{D} ) + \vert {E}_{I} \vert + \vert {E}_{D} \vert ) \qquad ( 1 )$$

where V and V′ are respectively the vertices of two graphs, v₁ and v_{D} are individual vertices inserted to and deleted from G, while E₁ and E_{D} are the edges added to and removed from G.

WGED presents the absolute difference between two graphs. This implies that wged(G, G′) is roughly proportional to the sum of graph sizes and therefore two larger graphs are likely to be more distant to one another. To eliminate this bias, the resulting distance is normalized and further defined with a Weighted Graph Similarity based on it.

Definition 3. The Weighted Graph Similarity of two Weighted Contextual API Dependency Graphs G and G′ with a weight function 0, is

$$wgs ( G , {G}^{′} , β ) = 1 - \frac{wged ( G , {G}^{′} , β )}{wged ( G , ∅ , β ) + wged ( ∅ , {G}^{′} , β )} \qquad ( 2 )$$

where; ₁ is an empty graph. wged(G, , β) +wged(, G′, β) then equates the maximum possible edit cost to transform G to G′.

4.2 Weight Assignment

Instead of manually specifying the weights on different APIs (in combination of their attributes), a near-optimal weight assignment is preferred.

Selection of Critical API Labels.

Given a large number of API labels (unique combinations of API names and attributes), it is unrealistic to automatically assign weights for all of them. As the goal is malware classification, system 10 concentrates on assigning weights to labels for the security-sensitive APIs and critical combinations of their attributes. To this end, system 10 performs concept learning to discover critical API labels. Given a positive example set (PES) containing malware graphs and a negative example set (NES) containing benign graphs, a critical API label (CA) is sought based on two requirements: 1) frequency(CA,PES)>frequency(CA,NES) and 2) frequency(CA,NES) is less than the median frequency of all critical API labels in NES. The first requirement guarantees that a critical API label is more sensitive to a malware sample than a benign one, while the second one ensures the infrequent presence of such an API label in the benign set. Consequently, 108 critical API labels have been selected. The goal becomes the assignment of appropriate weights to these 108 labels while assigning a default weight of 1 to all remaining API labels.

Weight Assignment.

Intuitively, if two graphs come from the same malware family and share one or more critical API labels, we want to maximize the similarity between the two. Such a pair of graphs is called a “homogeneous pair”. Conversely, if one graph is malicious and the other is benign, even if they share one or more critical API labels, the similarity between the two is minimized. Such a pair of graphs is referred to as a “heterogeneous pair”. Therefore, the problem of weight assignment is an optimization problem.

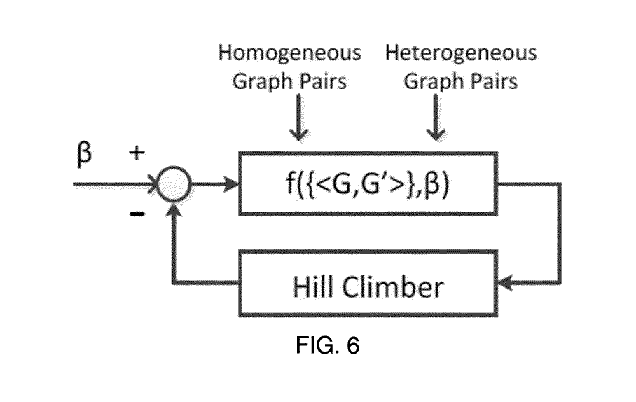

Definition 4. The Weight Assignment is an optimization problem to maximize the result of an objective function for a given set of graph pairs {<G,G′>}:

$$max f ( \{ 〈 G , {G}^{′} 〉 \} , β ) = {\sum }_{{〈 G , {G}^{′} 〉 is a}_{homogeneous pair}} wgs ( G , {G}^{′} , β ) - {\sum }_{{〈 G , {G}^{′} 〉 is a}_{heterogeneous pair}} wgs ( G , {G}^{′} , β ) \\ s . t . \\ 1 \leq β ( v ) \leq θ , if v is a critical node ; \\ β ( v ) = 1 , otherwise . \qquad ( 3 )$$

where β is the weight function that requires optimization; θ is the upper bound of a weight. Empirically, we set θ to be 20. To achieve the optimization of Equation 3, the Hill Climbing algorithm is used to implement a feedback loop that gradually improves the quality of weight assignment. FIG. 6 presents such a system, which takes two sets of graph pairs and an initial weight function β as inputs. β is a discrete function which is represented as a weight vector. At each iteration, Hill Climbing adjusts a single element in the weight vector and determines whether the change improves the value of objective function f({<G,G′>}, (3). Any change that improves f({<G, G′>}, (3) is accepted, and the process continues until no change can be found to further improve the value.

4.3 Implementation

To compute the weighted graph similarity, the bipartite graph matching tool was improved. The graph matching tool cannot be used directly because it does not support assigning different weights on different nodes in a graph. To work around this limitation, the bipartite algorithm was enhanced to support weights on individual nodes.

4.4 Graph Database Query

Given an app, its WC-ADGs are matched against all existing graphs in the database. The number of graphs in the database can be fairly large, so the design of the graph query must be scalable.

Intuitively, graphs could be inserted into individual buckets, with each bucket labeled according to the presence of critical APIs. Instead of comparing a new graph against every existing graph in the database, however, system 10 can limit the comparison to only the graphs within a particular bucket that possesses graphs containing a corresponding set of critical APIs. Critical APIs generally have higher weights than regular APIs, so graphs in other buckets will not be very similar to the input graph and are safe to be skipped. However, API-based bucket indexing may be overly strict because APIs from the same package usually share similar functionality. For instance, both getDeviceId( ) and getSubscriberId( ) are located in TelephonyManager package, and both retrieve identity-related information. Therefore, index buckets based on the package names of critical APIs are used instead.

More specifically, to build a graph database, an API package bitvector for all the existing graphs in the database must first be built. Such a bitvector has n elements, each of which indicates the presence of a particular Android API package. For example, a graph that calls sendTextMessage ( ) and getDeviceId ( ) will set the corresponding bits for the android. telephony.SmsManager and android.telephony.TelephonyManager packages. Graphs that share the same bitvector (i.e., the same API package combination) are then placed into the same bucket. When querying a new graph against the database, its API package combination is encoded into a bitvector and that bitvector is compared against each database index. Notice that, to ensure the scalability, the bucket-based indexing is implemented with a hash map, where the key is the API package bitvector and the value is a corresponding graph set.

Empirically, this one-level indexing was efficient enough for the present invention. If the database grows much bigger, a hierarchical database structure could be constructed, such as vantage point tree, under each bucket.

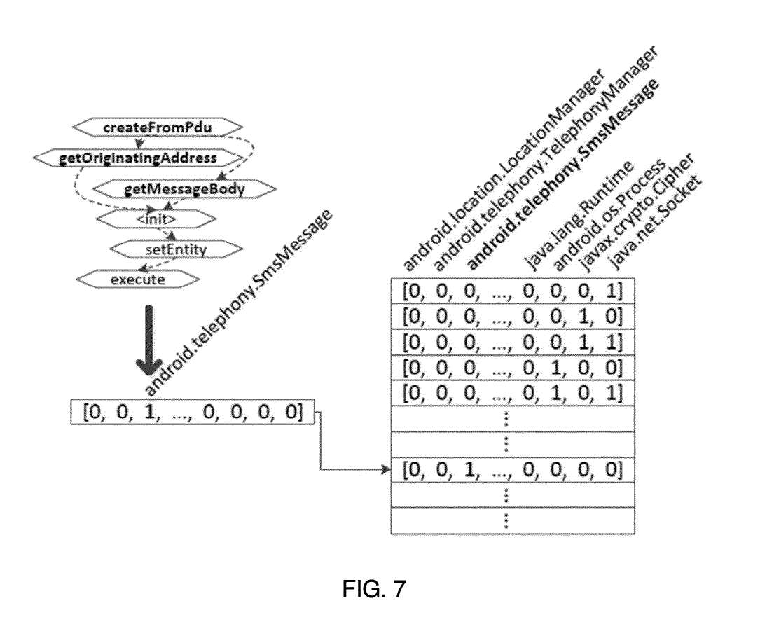

FIG. 7 demonstrates the bucket query for the WC-ADG of Zitmo shown in FIG. 3. This graph contains six API calls, three of which belong to a critical package: android. telephony.SmsManager. The generated bitvector for the Zitmo graph indicates the presence of this API package, and an exact match for the bitvector is performed against the bucket index. Notice that the presence of a single critical package is different from that of a combination of multiple critical packages. Thus, the result bucket in this search contains graphs that include android.telephony SmsManager as the only critical package in use. The extraction of the list of “critical” packages is mentioned in Section 4.2, while its validity is further justified in this example. Firstly, SmsManager being a critical package helps capture the SMS retrieval behavior and narrow down the search range. Secondly, since HTTP related API packages are not considered as critical, such an exact match over index will not exclude Zitmo variants using other I/O packages, such as raw sockets or SMS, for information stealing.

4.5 Malware Classification

Anomaly Detection.

A detector to conduct anomaly detection was implemented. Given an app, the detector provides a binary result that indicates whether the app is abnormal or not. To achieve this goal, a graph database was built for benign apps. The detector then attempts to match the WC-ADGs of the given app against the ones in database. If it cannot find a sufficiently similar one for any of the behavior graphs, an anomaly is then detected. The similarity threshold was set to be 70% according to empirical studies but could be set at any percentage as desired.

Signature Detection.

A classifier is realized to perform signature detection. The signature detector is a multi-label classifier designed to identify the malware families of unknown malware instances.

To enable classification, a malware graph database was built. To this end, static analysis was conducted on the malware samples from Android Malware Genome Project to extract WC-ADGs. In order to keep only the unique graphs, those graphs were removed that have a high level of similarity to existing ones. With experimental study, a high similarity was considered to be greater than 80%. Further, to guarantee the distinctiveness of malware behaviors, these malware graphs were compared against the benign graph set and common ones were removed.

Next, given an app, its feature vector for classification purposes is generated. In such a vector, each element is associated with a graph in the database. And in turn, all the existing graphs are projected to a feature vector. In other words, there exists a one-to-one correspondence between the elements in a feature vector and the existing graphs in the database. To construct the feature vector of the given app, its WC-ADGs is produced and then the graph database is queried for all the generated graphs. For each query, a best matching one is found. The similarity score is then put into the feature vector at the position corresponding to this best matching graph. Specifically, a feature vector of known malware sample is attached with its family label, so that the classifier can understand the discrepancy between different malware families.

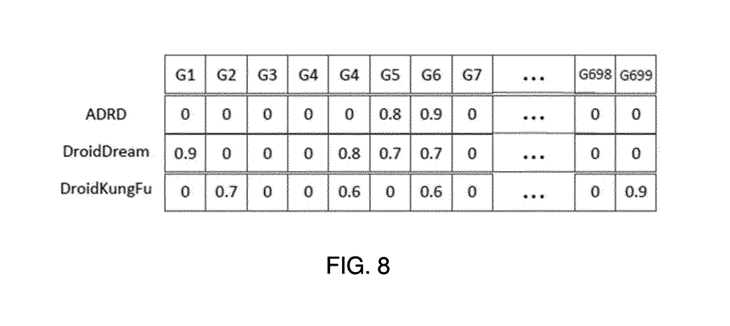

FIG. 8 gives an example of feature vectors. In our malware graph database of 699 graphs, a feature vector of 699 elements is constructed for each app. The two behavior graphs of ADRD are most similar to graph G5 and G6, respectively, from the database. The corresponding elements in the feature vector are then set to be their similarity scores, while the rest of the elements remain as zero.

Once the feature vectors for training samples are produced, they can be used to train a classifier. Naïve Bayes algorithm was selected for the classification, but different algorithms could be used for the same purpose. However, since graph-based features are fairly strong, even Naïve Bayes can produce satisfying results. Naïve Bayes also has several advantages: it requires only a small amount of training data; parameter adjustment is straightforward and simple; and runtime performance is favorable.

5. Evaluation

5.1 Dataset & Experiment Setup

Malware samples were collected from both Android Malware Genome Project and a leading antivirus company, and in total a collection of 2200 malware instances was used. We also receive clean samples from the antivirus company. In addition, popular apps bearing high ranking were downloaded from Google Play to build the benign dataset. To further sanitize the dataset, the apps were sent to VirusTotal service for inspection, and eventually, 9500 benign samples were acquired.

To enable anomaly and signature malware detection, behavior graph generation, graph database creation, graph similarity query, and feature vector extraction were performed with the dataset. The experiments were conducted on a test machine, which was equipped with an Intel(R) Xeon(R) E5-2650 CPU (20M Cache, 2 GHz) and 128 GB of physical memory. The operating system is Ubuntu 12.04.3 (64 bit).

5.2 Summary of Graph Generation

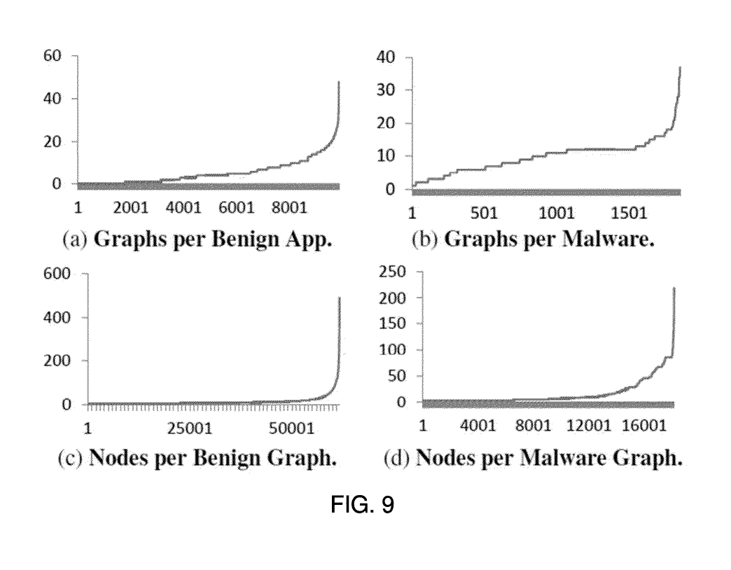

FIG. 9 summarizes the characteristics of the behavior graphs generated from both benign and malicious apps. Among them, FIG. 9a and FIG. 9b illustrate the amount of graphs generated from benign and malicious apps. On average, 7.7 graphs are computed from one clean app, while 9.8 graphs are generated from a malware instance. Most apps focus on limited functionalities and thus do not produce a large number of behavior graphs. As a matter of fact, in 95% of clean samples and 98% of malicious ones, no more than 20 graphs are produced from an individual app.

FIG. 9c and FIG. 9d present the number of nodes of benign and malicious behavior graphs. A benign graph, on average, has 12.8 nodes, while a malicious graph carries 16.4. Again, most of the activities are not intensive, and consequently, a majority of these graphs has a small number of nodes. Statistics show that 95% of benign graphs and 91% of malicious ones carry less than 50 nodes. These facts serve as the basic requirements for the scalability of our approach, since the runtime performance of graph matching and query largely depends on the number of nodes and graphs, respectively.

5.3 Classification Results

Signature Detection.

A multi-label classification and identification of the malware family of unrecognized malicious samples was pursued. Therefore, only those malware behavior graphs that are well labeled with family information are preferable included into the database. To this end, malware samples from Android Malware Genome Project were used to construct the malware graph database. Consequently, a database of 699 unique behavior graphs was built, each of which is labeled with a specific malware family.

630 malware samples were selected from the Android Malware Genome Project for use as training set. Next, 193 samples were used as test samples, each of which was detected as the same malware by major AVs. The experimental result shows that system 10 can correctly label 93% of these malware instances.

Among the successfully labeled malware samples, there exist two types of Zitmo variants. One exploits HTTP and the other uses SMS for communication. While the former one was present in the test malware database, the latter one was not. Nevertheless, the signature detector of system 10 was still able to capture this variant. This indicates that the similarity metrics effectively tolerate variations in behavior graphs.

The 7% of samples that were mislabeled was analyzed. It turns out that the mislabeled cases can be roughly put into two categories. First, DroidDream samples are labeled as DroidKungFu. DroidDream and DroidKungFu share multiple malicious behaviors such as gathering privacy-related information and hidden network I/O. Consequently, there exists a significant overlapping between their WC-ADGs. Second, Zitmo, Zsone and YZHC instances are labeled as one another. These three families are SMS Trojans. Though their behaviors are slightly different from each other, they all exploit sendTextMessaqe ( ) to deliver the user's information to an attacker specified phone number. Despite the mislabeled cases, we still manage to successfully label 93% of the malware samples with a Naïve Bayes classifier. Applying a more advanced classification algorithm would further improve the accuracy.

Anomaly Detection.

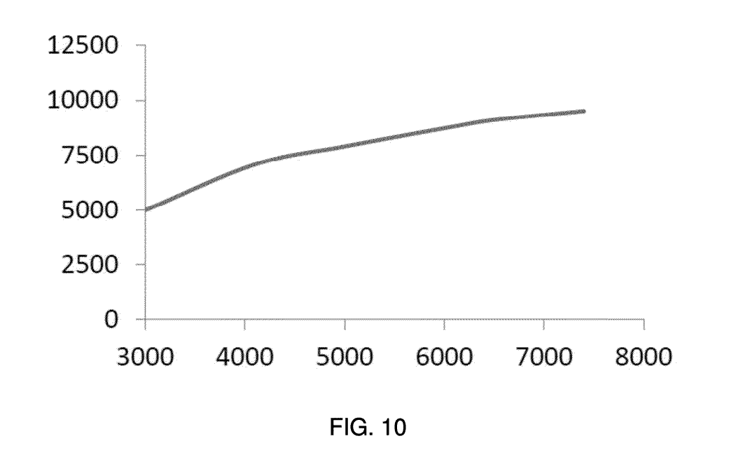

Since we would like to perform anomaly detection with our benign graph database, the coverage of this database is then essential. In theory, the more clean apps the database collects, the more benign behaviors it covers. However, in practice, it is extremely difficult to retrieve benign apps exhaustively. Luckily, different benign apps may share the same behaviors. Therefore, unique behaviors can be focused on rather than unique apps. Moreover, with more and more apps being fed into the benign database, the database size grows slower and slower. FIG. 10 depicts this discovery. When the amount of apps rises from 3000 to 4000, there exists a sharp increase (2087) of unique graphs. However, when the number of apps grows from 6000 to 7000, only 400 new unique graphs are generated, and the curve starts to become flat.

As a result, a database of 9510 unique graphs from 7400 benign apps was built. Then, we first test 2200 malware samples against the benign classifier. The false negative rate is 2%, which means that 42 malware instances were not detected. However, we notice that most of the missed samples are in fact exploits or Downloaders. In these cases, their bytecode programs do not bear significant API level behaviors, and therefore the generated WC-ADGs do not necessarily look abnormal compared to clean ones. The test version of system 10 only considered the presence of constant parameters in an API call, but did not further differentiate API behaviors based on constant values. Therefore, it could not distinguish the behaviors of Runtime.exec ( ) calls or network I/O APIs with varied string inputs. Nevertheless, if a custom filter is created for these string constants, system 10 can identify these malware as well and the false negative rate will drop to 0.

Next, the remaining 2100 benign apps were used as test samples to evaluate the false positive rate of the anomaly detector. The result shows that 6.3% of clean apps are mistakenly recognized as suspicious ones during anomaly detection. This means, if our anomaly detector is applied to Google Play, among the approximately 1200 new apps per day, around 70 apps will be mislabeled as anomalies and bounced back to the developers. This is an acceptable ratio for initial vetting purpose. Moreover, since system 10 does not reject the suspicious apps immediately but asks developers for justifications instead, these false positives can be eliminated during the interactive process. In addition, as more benign samples are added into the dataset, the false positive rate will further decrease.

Detection of Transformation Attacks.

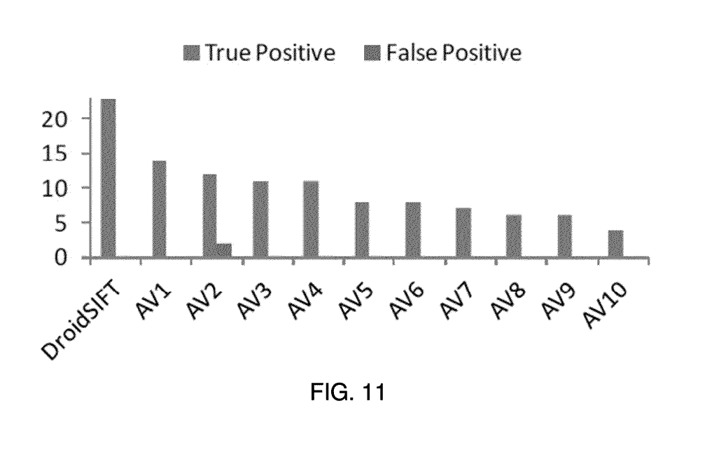

23 DroidDream samples were collected and intentionally obfuscated with transformation technique, and 2 benign apps were deliberately disguised as malware instances by applying the same technique. These samples were run first through the anomaly detection engine and then the detected abnormal ones are further sent to the signature detector. The result shows that while 23 true malware instances are flagged as abnormal ones in anomaly detection, the 2 clean ones also correctly pass the detection without raising any warnings. The signature detection results were compared with antivirus products. To obtain detection results of antivirus software, these samples were sent to VirusTotal and select 10 products (i.e., AegisLab, F-Prot, ESET-NOD32, DrWeb, AntiVir, CAT-QuickHeal, Sophos, F-Secure, Avast and Ad-Aware) that bear the highest detection rates. A detection is successful only if the AV can correctly flag a piece of malware as DroidDream or its variant. In fact, many AV can provide partial detection results based on the native exploit code included in the app package or common network I/O behaviors. As a result, they usually recognize these DroidDream samples as “exploits” or “Downloaders” while missing many other important malicious behaviors. FIG. 11 presents the detection ratios of “DroidDream” across different detectors. While none of the antivirus products can achieve a detection rate higher than 61%, DroidSIFT can successfully flag all of the obfuscated samples as DroidDream instances. In addition, we also notice that though AV2 produces a relatively high detection ratio (52.17%), it also mistakenly flags the two clean samples as malicious apps. Since the disguising technique simply renames the benign app package to the one commonly used by DroidDream and thus confuses this AV detector, such false positives again explain that external symptoms are not robust and reliable features for malware detection.

5.4 Runtime Performance

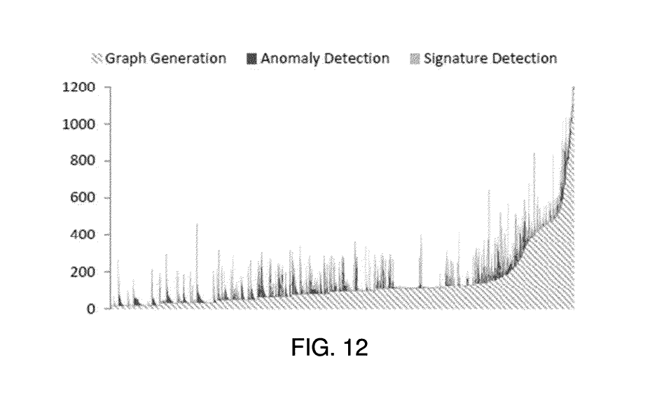

FIG. 12 illustrates the runtime performance of DroidSIFT. Specifically, it demonstrates the accumulative time consumption of graph generation, anomaly detection and signature detection for 3000 apps.

The average detection runtime of 3000 apps is 175.8 seconds, while the detection for a majority (86%) of apps is completed within 5 minutes. Further, most of the apps (96%) can be processed within 10 minutes. The time cost of graph generation dominates the overall runtime, and takes up at least 50% of total runtime for 83.5% of the apps. On the other hand, the signature and anomaly detectors are usually (i.e., in 98% of the cases) able to finish running in 3 minutes and 1 minute, respectively.

5.5 Effectiveness of Weight Generation and Weighted Graph Matching

The effectiveness of the generated weights and weighted graph matching was evaluated.

The weight generation of system 10 automatically assigns weights to the critical API labels, based on a training set of homogeneous graph pairs and heterogeneous graph pairs. Consequently, killProcess ( ), getMemoryInfo( ) and sendTextMessage( ) with a constant phone number, for example, are assigned with fairly high weights. Then, given a graph pair sharing the same critical API labels, other than the pairs used for training, their weighted graph similarity is compared with the similarity score calculated by standard bipartite algorithm. To test, 250 homogeneous pairs and 250 heterogeneous pairs were randomly picked.

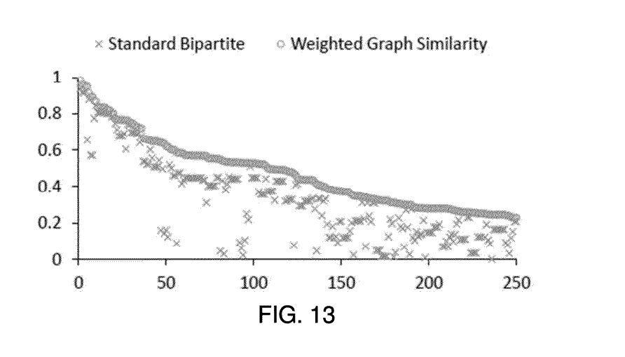

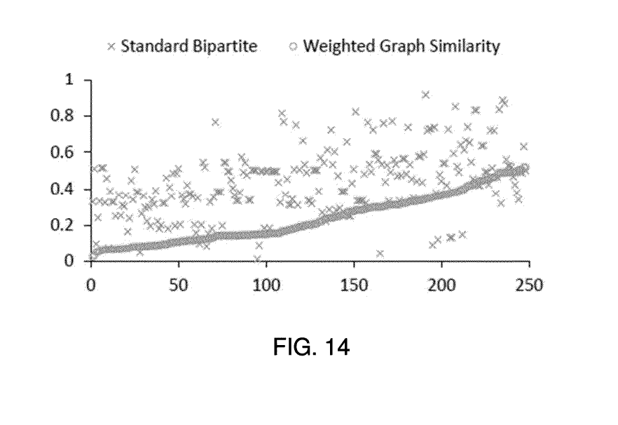

The results of the comparisons, presented in FIG. 13 and FIG. 14, conform to our expectation. FIG. 13 shows that for every homogeneous pair, the similarity scores generated by weighted graph matching are almost always higher than the corresponding ones computed using standard bipartite algorithm. In addition, bipartite algorithm sometimes produces an extremely low similarity (i.e., near zero) between two malicious graphs of the same family, while weighted graph matching manages to improve the similarity significantly in these cases.

Similarly, FIG. 14 reveals that between a heterogeneous pair, the weighted similarity score is usually lower than the one from bipartite computation. Again, bipartite algorithm occasionally considers a benign graph considerably similar to a malicious one, provided they share the same API nodes. Such results can confuse a training system and the latter one thus fails to tell the differences between malicious and benign behaviors. On the other hand, weighted graph matching can effectively distinguish a malicious graph from a clean one, even if they both have the same critical API nodes.

The standard bipartite algorithm was implemented and applied to the detectors. The consequent detection results were compared with those of the detectors with weighted graph matching enabled. The results show that weighted graph matching significantly outperforms the bipartite one. While the signature detector using the former one correctly labels 93% of malware samples, the detector with the latter one can only label 73% of them. On the other hand, anomaly detection with bipartite algorithm incurs a false negative rate of 10%, which is 5 times as much as that introduced by the same detection but with weighted matching.

The result indicates that system 10 is more sensitive to critical API-level semantics than the standard bipartite graph matching, and thus can produce more reasonable similarity scores for the feature extraction.

6.1 Native Code & HTML5-based Apps

Static analysis was performed on Dalvik bytecode to generate the behavior graphs. In general, bytecode-level static program analysis cannot handle native code or HTML5-based applications. This is because neither the ARM binary running on underlying Linux nor the JavaScript code executed in WebView is visible from bytecode perspective. Therefore, an alternative mechanism is desired to defeat malware hidden from Dalvik bytecode.

6.2 Evasion

Learning-based detection is subject to poisoning attacks. To confuse a training system, an adversary can poison the benign dataset by introducing clean apps bearing malicious features. For example, she can inject harmless code intensively making sensitive API calls that are rarely observed in clean apps. Once such samples are accepted by the benign dataset, these APIs are therefore no longer the distinctive features to detect related malware instances.

However, the detectors of system 10 are slightly different from prior works. First of all, the features are associated with behavior graphs rather than individual APIs. Therefore, it is much harder for an attacker to engineer behavioral-level confusing samples. Second, the anomaly detection serves as a sanitizer for new benign samples, because any abnormal behavior is going to be detected and the developer is requested to provide justifications.

On the other hand, in theory, it is possible for adversaries to launch mimicry attacks and embed malicious code into seemingly benign graphs to evade our detection mechanism. This by itself is an interesting research topic and deserves serious studies. Nevertheless, it is non-trivial exercise to evade detections based on high-level program semantics, and automating such evasion attacks do not seem to be easy. In contrast, the existing low-level transformation attacks can be easily automated to generate many malware variants to bypass the AV scanners. DroidSIFT certainly defeats these evasion attempts.

Thus, system 10 involves a semantic-based approach that classifies Android malware via dependency graphs. To battle transformation attacks, a weighted contextual API dependency graph is extracted as program semantics to construct feature sets. To fight against malware variants and zero-day malware, graph similarity metrics are used to uncover homogeneous application behaviors while tolerating minor implementation differences. A prototype system was implemented in DroidSIFT in 23 thousand lines of Java code and evaluated using 2200 malware samples and 9500 benign samples. Experiments show that the signature detection of system 10 can correctly label 93% malware instances, and the anomaly detector of system 10 is capable of detecting zero-day malware with relatively low false negative rate (2%) and false positive rate (6.3%).

What is claimed is:

1. A malware detection system, comprising:
a detection server interconnected to an application market for receiving an unknown application and to a database containing a plurality of behavior graphs associated with known malware and known benign ware, wherein the detection server includes:
a first module programmed to receive a unknown application and to generate a behavior graph of the unknown application using static analysis;
a second module programmed to perform a similarity query between the behavior graph of the unknown application and the plurality of behavior graphs in the database; and
a third module programmed to determine whether the unknown application is malware based on the results of the similarity query.

2. The system of claim 1, wherein the first module is programmed to generate the behavior graph based on application program interface (API) dependency.

3. The system of claim 2, wherein the second module is programmed to use a bucket based indexing scheme.

4. The system of claim 3, wherein the second module is programmed to identify a matching bucket having less graphs than all of the plurality of behavior graphs and to further iterate the matching bucket to find a best matching graph from the graphs in the bucket.

5. The system of claim 4, wherein the second module finds a best matching graph using feature vectors.

6. The system of claim 5, wherein the feature vectors are weighted.

7. A method of determining whether an unknown application is malware, comprising the steps of:
providing a detection server interconnected to an application market for receiving an unknown application and to a database containing a plurality of behavior graphs associated with known malware and known benign ware, wherein the detection server includes a first module programmed to receive a unknown application and to generate a behavior graph of the unknown application using static analysis, a second module programmed to perform a similarity query between the behavior graph of the unknown application and the plurality of behavior graphs in the database, and a third module programmed to determine whether the unknown application is malware based on the results of the similarity query;
receiving an unknown application from an application marketplace by the detection server;
evaluating the unknown application with the first module of the detection server to produce a behavior graph;
performing a similarity query with the second module of the server to identify a matching behavior graph in the plurality of graphs in the database; and
determining whether the unknown application is malware based on the results of the similarity query.

8. The method of claim 7, wherein the first module is programmed to generate the behavior graph based on application program interface (API) dependency.

9. The method of claim 8, wherein the second module is programmed to use a bucket based indexing scheme.

10. The method of claim 9, wherein the second module is programmed to identify a matching bucket having less graphs than all of the plurality of behavior graphs and to further iterate the matching bucket to find a best matching graph from the graphs in the bucket.

11. The method of claim 10, wherein the second module finds a best matching graph using feature vectors.

12. The method of claim 11, wherein the feature vectors are weighted.
